(19) United States
(12) Patent Application Publication
(10) Pub. No.: US 2025/0261238 A1
(43) Pub. Date: Aug. 14, 2025

(54) DYNAMIC CONFIGURATION OF RANDOM ACCESS COMMUNICATIONS

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 18/441,855

(22) Filed: Feb. 14, 2024

(51) Int. Cl. H04W 74/0833; H04L 5/00

(52) U.S. Cl. CPC H04W 74/0833; H04L 5/0044

(57) ABSTRACT

Certain aspects of the present disclosure provide techniques for dynamic configuration of random access communications. A method for wireless communications by an apparatus includes obtaining, via a first type of signaling, a configuration that indicates at least a first set of parameters for random access communications; obtaining, via one or more of a second type of signaling or a payload scheduled by the second type of signaling, an indication of a modification to the configuration, wherein the modification is based on a second set of parameters that are indicated via one or more of: the configuration, the second type of signaling, or the payload, and wherein the first type of signaling is different from the second type of signaling; and communicating, with a network entity, via a random access channel, based at least in part on the modification to the configuration.

### INTRODUCTION

### Field of the Disclosure

Aspects of the present disclosure relate to wireless communications, and more particularly, to techniques for random access communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining, via a first type of signaling, a configuration that indicates at least a first set of parameters for random access communications; obtaining, via one or more of a second type of signaling or a payload scheduled by the second type of signaling, an indication of a modification to the configuration, wherein the modification is based on a second set of parameters that are indicated via one or more of: the configuration, the second type of signaling, or the payload, and wherein the first type of signaling is different from the second type of signaling; and communicating, with a network entity, via a random access channel, based at least in part on the modification to the configuration.

Another aspect provides a method for wireless communications by an apparatus. The method includes sending, via a first type of signaling, a configuration that indicates at least a first set of parameters for random access communications; sending, via one or more of a second type of signaling or a payload scheduled by the second type of signaling, an indication of a modification to the configuration, wherein the modification is based on a second set of parameters that are indicated via one or more of: the configuration, the second type of signaling, or the payload, and wherein the first type of signaling is different from the second type of signaling; and communicating, with a user equipment, via a random access channel, based at least in part on the modification to the configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5A depicts an example four-step random access procedure.

FIG. 5B depicts an example two-step random access procedure.

FIG. 6 depicts an example architecture for dynamic configuration of random access communications.

FIG. 7 depicts example mappings of synchronization signal blocks (SSBs) to random access occasions (ROs) in time-frequency domains for sets of random access parameters.

FIG. 8 illustrates other example mappings of SSBs to ROs in time-frequency domains for sets of random access parameters.

FIG. 9 depicts a process flow for dynamic configuration of random access communications.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for dynamic configuration of random access communications.

In certain wireless communication systems (e.g., 5G New Radio systems and/or any future wireless communications system), a user equipment (UE) may communicate with a network entity (e.g., a base station) using a random access procedure, for example, for initial access to the network entity, for beam failure recovery, to obtain timing information (e.g., a timing advance), to request uplink communication resources, to request system information, etc. An example random access procedure may begin with the UE sending a random access preamble on a physical random access channel (PRACH) in a random access occasion (RO), which may include one or more time-frequency resources. Upon successful reception of the preamble, the network entity sends a response to the preamble in a random access response (RAR) window. The response may include an uplink scheduling grant. On receiving the response, the UE may send a request to setup a connection with the network entity, and then, the network entity may reply with a contention resolution response.

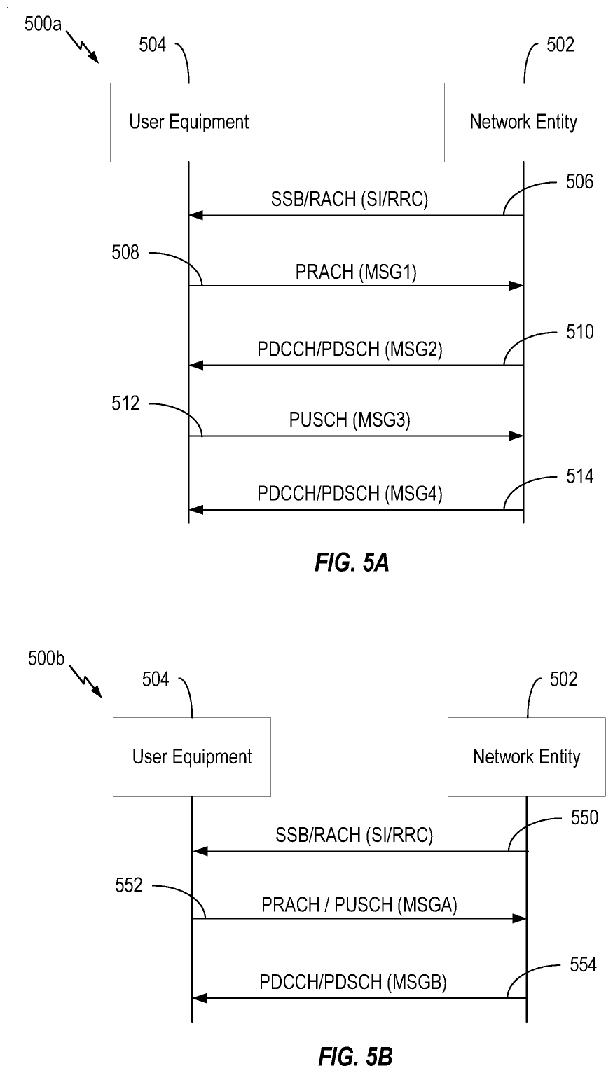

In certain cases, a UE obtains a configuration for random access communications via system information that is broadcast by the network entity. The configuration may identify certain parameters for random access communications, such as a set of preambles, a periodicity for the ROs, and/or a duration for the RAR window. Certain aspects associated with random access communications are further described herein, for example, with respect to FIGS. 5A and 5B.

Technical problems for random access communications include, for example, effectively communicating, to UE(s), a reconfiguration for random access communications. In certain cases, a network entity may decide to reconfigure the configuration for random access communications, for example, in response to time varying traffic levels or network capacity. As an example, the network entity may decide to reconfigure the configuration for random access communications in order to enable certain energy savings, for example, when the traffic level is relatively low. The network entity may increase the periodicity for the ROs, reduce the duration for the RAR window, and/or reduce the number of frequency division multiplexed ROs per time instance of an RO in order to reduce the power consumption associated with random access communications.

As discussed, random access communications may be configured via system information. Such system information is communicated by a network entity on a periodic basis, for example, with a periodicity that can be as long as 160 milliseconds (ms). In certain cases, the network entity may notify UEs via downlink control information (DCI) that the system information, which includes the configuration for random access communication, has been modified. This notification may trigger a UE to obtain the updated system information in the next transmission occasion for the system information, which can be as long as 160 milliseconds. Accordingly, updating the configuration for random access communications may use a non-trivial amount of time due to the updating procedure depending on the periodicity of system information to convey the updated configuration.

In certain cases, the network entity may update the system information without notifying the UEs about the update relying on the UEs to occasionally check the system information being broadcast by the network entity. However, some UEs may refrain from checking for updated system information once the system information is initially received at the UE. Accordingly, some UEs may attempt to communicate with the network entity via a random access channel using an obsolete configuration for random access communications.

Aspects described herein overcome the aforementioned technical problem(s) by providing dynamic configuration of random access communications. In certain aspects, a UE may be configured with multiple configurations for random access communications, and the UE may obtain, from a network entity, an indication to switch to a specific configuration among the multiple configurations. In certain aspects, the UE may obtain an indication of an updated set of parameter to a configuration for random access communications, for example, via DCI and/or a payload scheduled via the DCI. Accordingly, such schemes for communicating a reconfiguration for random access communications enable reduced latency in signaling the reconfiguration to a UE.

The techniques for dynamic configuration of random access communications as described herein may provide various beneficial technical effects and/or advantages. The techniques for dynamic configuration of random access communications may enable reduced latency in modifying random access parameter(s) at a UE. The techniques for dynamic configuration of random access communications may provide an effective technique for switching between sets of random access parameters in response to various conditions, such as changes in wireless traffic levels and/or network loads over time. The dynamic configuration may allow a network entity to switch to random access parameters that enable energy savings at the network entity and/or UE, for example, when traffic levels and/or network loads are low.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

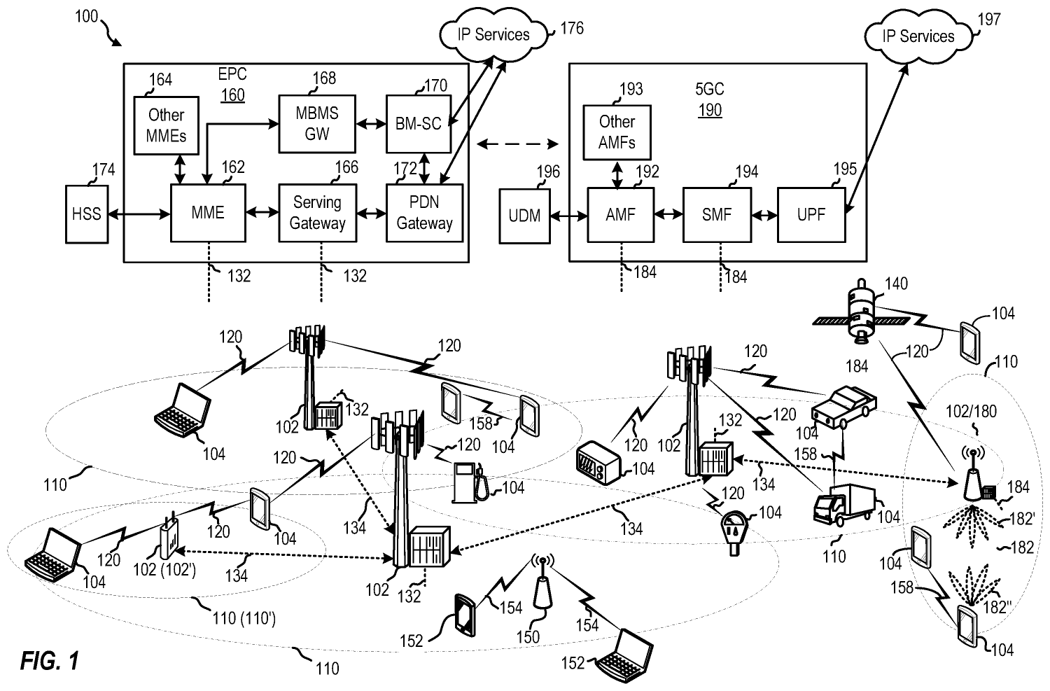

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

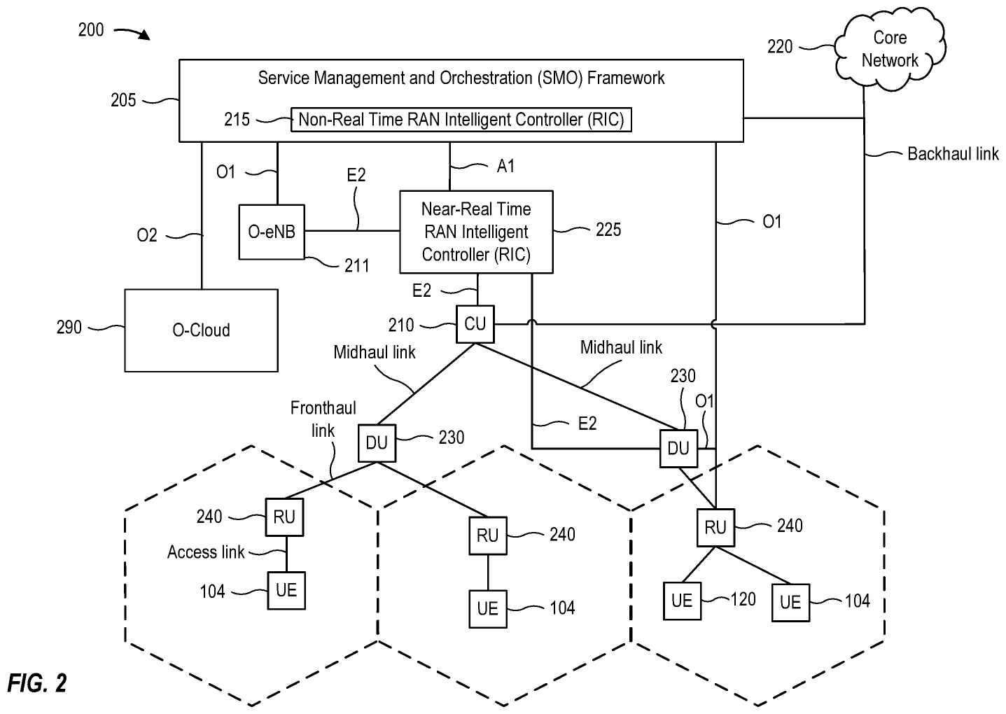

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mm W” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

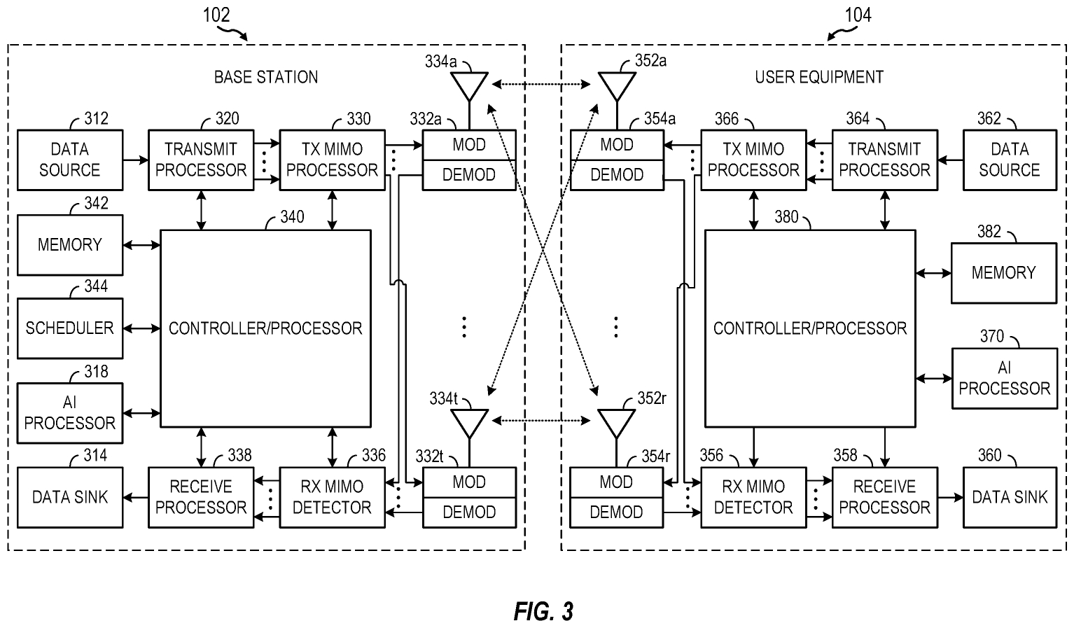

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

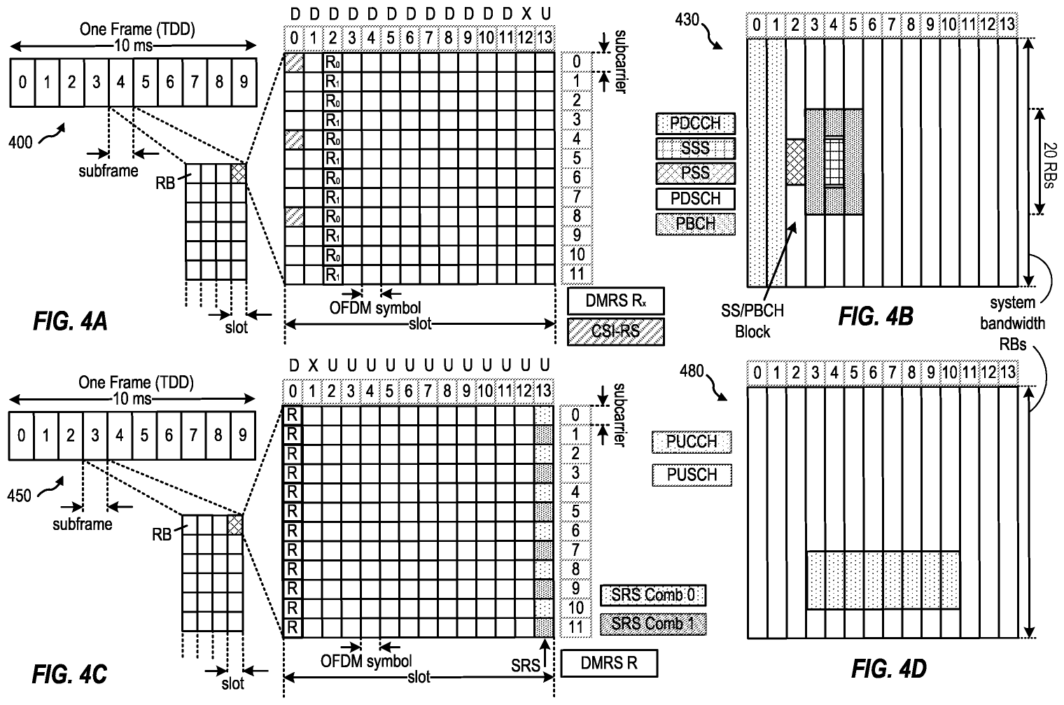

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology u=0 corresponds to a subcarrier spacing of 15 kHz, and the numerology u=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures

Certain wireless communication systems (e.g., a 5G NR system and/or any future wireless communications system) may provide a specified channel for random access, such as a random access channel (RACH), and corresponding random access procedures. A random access procedure may be performed for any of various events including, for example, initial access from an idle state (e.g., RRC idle), RRC connection re-establishment, handover, downlink (DL) and/or uplink (UL) data arrival (e.g., when the UE is in an idle state), or device positioning.

FIG. 5A depicts a process flow diagram of an example four-step RACH procedure 500a performed between a UE 504 and a network entity 502. In some aspects, the UE 504 is the UE 104 depicted and described with respect to FIGS. 1 and 3, and the network entity 502 is the base station 102 depicted and described with respect to FIGS. 1 and 3 or a disaggregated base station depicted and described with respect to FIG. 2.

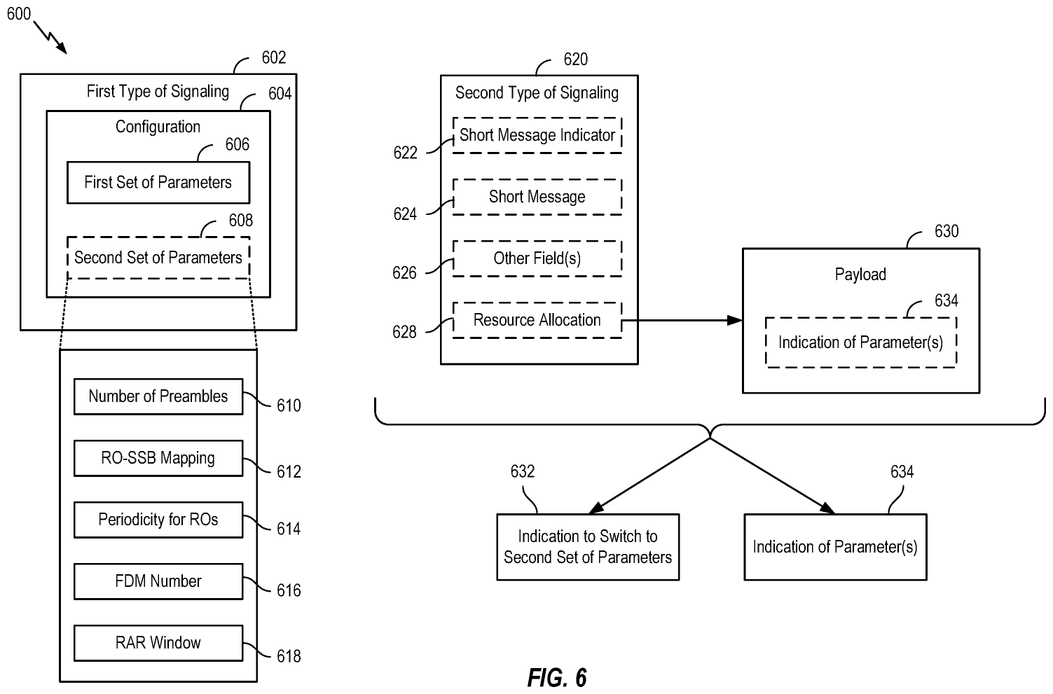

The RACH procedure 500a may optionally begin at 506, where the network entity 502 broadcasts and the UE 504 receives a random access configuration, for example, in system information within a synchronization signal block, or within an RRC message. The random access configuration may indicate or include one or more parameters for random access communications, such as defining the RACH, the number of random access preambles (e.g., preamble sequences) available for random access, power ramping parameters, response window size (duration), etc. In certain aspects, the UE 504 may obtain an indication of a modification to the random access configuration, for example, as further described herein with respect to FIGS. 6-9.

At 508, the UE 504 sends a first message (MSG1) to the network entity 502 on a physical random access channel (PRACH). In certain aspects, MSG1 may indicate or include a RACH preamble. The RACH preamble may be or include a preamble sequence (e.g., a Zaddoff Chu sequence). For contention-based random access, the preamble sequence may be randomly selected among a set of preamble sequences (e.g., up to 64 sequences, in some cases). The preamble sequence may be used to identify the UE 504 for scheduling communications (e.g., MSG2 and MSG3) with the network entity. In certain aspects, terms such as “RACH preamble,” “random access preamble,” “preamble,” “preamble sequence,” “sequence,” and the like may be used interchangeably.

At 510, the network entity 502 may respond with a random access response (RAR) message (MSG2). For example, the network entity 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble sequence and indicate that the RAR is for the UE 504 that transmitted MSG1 at 506. The backoff parameter value may be used to determine a RACH occasion (RO) for sending a subsequent RACH transmission (e.g., a preamble transmission). A RACH occasion may correspond to one or more time-frequency resources available for transmitting a preamble in a RACH.

At 512, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (for an UL transmission). As an example, MSG3 is communicated in the time-frequency resource(s) indicated in the UL grant of the RAR.

At 514, the network entity 502 may send a contention resolution message (MSG4) in response to MSG3. In certain cases, multiple UEs may send the same preamble in the same RO. As the network entity 502 may not be able to identify which UE sent which preamble, the network entity 502 may reply with a single RAR associated with the preamble. The MSG3 may include or indicate a specific UE identity associated with the UE 504, such as a radio network temporary identifier (RNTI) or a temporary mobile subscriber identity (TMSI). The network entity 502 may decode MSG3 and determine the UE identity associated with at least one of the UEs (e.g., UE 504). MSG4 may be addressed to the UE identity (e.g., the RNTI or an RNTI based on the TMSI) associated with the MSG3 that the network entity was able to successfully decode. For example, the MSG4 may be scrambled by the RNTI associated with the MSG3. If the UE 504 obtains the same identity sent in MSG3, the UE 504 concludes that the random procedure succeeded. In some cases, if the UE 504 is unable to obtain or decode MSG3 and/or MSG4, the UE 504 may repeat the RACH procedure, such as the four-step RACH procedure 500a.

In some cases, to reduce the latency associated with random access, a two-step RACH procedure may be used. As the name implies, the two-step RACH procedure may effectively consolidate the four messages of the four-step RACH procedure into two messages.

FIG. 5B depicts a process flow diagram of an example two-step RACH procedure 500b performed between the UE 504 and the network entity 502.

The procedure 500b may optionally begin at 550, where the network entity 502 broadcasts and the UE 504 receives a random access configuration, for example in system information within a synchronization signal block, or within an RRC message.

At 552, the UE 504 sends a first message (MSGA) to the network entity 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the RACH, and the payload of MSGA may be transmitted over the PUSCH, for example.

At 554, the network entity 502 may send a random access response message (MSGB), which may effectively combine MSG2 and MSG4 described above. For example, MSGB may include a RAPID, a timing advance, a backoff parameter value, a contention resolution message, an uplink and/or downlink grant, and transmit power control commands.

### Aspects Related to Dynamic Configuration of Random Access Communications

Aspects of the present disclosure provide dynamic configuration of random access communications. As an example, a UE may obtain a reconfiguration for random access parameters via paging signaling, which may be broadcast or multicast to multiple UEs. In certain aspects, the reconfiguration may indicate to switch to preconfigured parameters, for example, communicated in system information. In certain aspects, the reconfiguration may carry the modified parameters in the paging signaling and/or a payload scheduled by the paging signaling.

FIG. 6 illustrates an example architecture 600 for dynamic configuration of random access communications. In this example, a UE may obtain, from a network entity via a first type of signaling 602, a configuration 604 that indicates or includes at least a first set of parameters 606 for random access communications. A “set” as discussed herein may include one or more elements. In certain aspects, the first type of signaling 602 may indicate that the first set of parameters 606 are default parameter(s) for random access communications and/or indicate that the first set of parameters 606 are the active set of parameters being used currently at or by the network entity. In some cases, the configuration 604 may further indicate or include a second set of parameters 608 for random access communications. The first type of signaling 602 may indicate that the second set of parameters 608 are an alternative set of parameters that can be activated or triggered for use as further described herein. The first type of signaling 602 may be or include system information, such as SIB1. As an example, the configuration may be or include a RACH configuration (e.g., RACH-ConfigCommon) used to specify cell specific random-access parameter(s).

The second set of parameters 608 may be or include certain random access parameter(s). In certain aspects, the second set of parameters 608 may be configured to enable energy savings for random access communications. For example, the network entity may use or activate the second set of parameters when there is a low level of traffic, for example, during the night; whereas the network entity may use or activate the first set of parameters, when there is an increased level of traffic, for example, during the day. The second set of parameters 608 may be or include one or more of: a total number of random access preambles 610 available for random access communications; an indication of a mapping of a set of random access occasions (ROs) to one or more synchronization signal blocks (SSBs) (RO-SSB mapping) 612; a periodicity 614 for the set of ROs (e.g., based on a PRACH configuration index); a total number of one or more ROs that can be frequency division multiplexed (FDM) in a time instance associated with a single RO (hereinafter “the FDM number 616”); or a duration of a random access response (RAR) window 618. In certain aspects, the second set of parameters 608 may be configured to adjust (e.g., reduce or increase) the random access communications activity of the network entity and/or one or more UEs with respect to the first set of parameters 606. For example, the second set of parameters 608 may increase the periodicity for the set of ROs 614, reduce the total number of preambles 610, reduce the FDM number 616, and/or reduce the RAR window 618. Note that other parameter(s) may be included in the second set of parameters in addition to or instead of those discussed above, such as a number of RACH slots per radio frame and/or a PRACH configuration index.

In certain aspects, one or more look-up tables may define various sets of random access parameters, and a PRACH configuration index may be used to identify a specific set of parameter(s) in the look-up table(s). The PRACH configuration index may be associated with a particular row of parameter(s) in the look-up table(s). As an example, the PRACH configuration index may indicate certain parameters that define the time-domain position of RO(s) including, for example, the periodicity for the set of ROs 614 based on the radio frame(s) and/or the subframe(s) that include RO(s) defined by the PRACH configuration index. In some cases, the PRACH configuration index may indicate that every radio frame includes RO(s). In certain cases, the PRACH configuration index may indicate that every other radio frame includes ROs. As an example, the PRACH configuration index may indicate that there is a single RO every 160 ms. As another example, the PRACH configuration index may indicate that there are 24 time multiplexed ROs every 20 ms. The FDM number may allow for multiple ROs to be multiplexed in the frequency domain per RO in the corresponding radio frames and subframes configured with time domain positions for RO(s). Accordingly, the periodicity and/or other parameter(s) for random access communications may be indicated with respect to a PRACH configuration index, and the second set of parameters 608 may indicate or include a PRACH configuration index.

In certain aspects, the second set of parameters 608 may adjust the RO(s) available for random access communications based on the arrangement of RO(s) configured by the first set of parameters 606, or vice versa. In certain cases, the second set of parameters 608 may identify a subset of the RO(s) configured by the first set of parameters 606. The RO(s) available for random access communications based on the second set of parameters 608 may be a sub-selection of RO(s) configured based on the first set of parameters 606. In some cases, the RO(s) available for random access communications based on the first set of parameters 606 may be a sub-selection of RO(s) configured based on the second set of parameters 608. Accordingly, the PRACH configuration index associated with the second set of parameters 608 may be a value that allows for a sub-selection of RO(s) configured based on the first set of parameters 606, or vice versa.

After obtaining the first type of signaling 602, the UE may obtain, from the network entity, a second type of signaling 620 that indicates to switch from the first set of parameters 606 to the second set of parameters 608 (e.g., a first indication 632 to switch to the second set of parameters 608) and/or indicates at least one parameter of the second set of parameters 608 (e.g., a second indication 634 of at least one parameter of the second set of parameters 608). The first indication 632 may be or include an index or a specific value that indicates or selects the second set of parameters 608. The second indication 634 may be or include a parameter value and/or an index of a parameter value associated with at least one parameter of the second set of parameters. As an example, the second indication 634 may be or include a value for the number of preambles 610, an index for the RO-SSB mapping 612, a duration for the periodicity 614, a value for the FDM number 616, and/or a duration for the RAR window 618.

The second type of signaling 620 may be a different type of signaling than the first type of signaling 602. For example, where the first type of signaling 602 may be system information, such as a SIB, the second type of signaling 620 may be a different signaling than SIB, such as DCI. In certain aspects, the second type of signaling 620 may indicate to toggle to the second set of parameters 608 for random access communications. In certain aspects, the second type of signaling 620 may indicate setting(s) for the second set of parameters 608. In certain aspects, the second type of signaling 620 may be communicated via DCI. The second type of signaling 620 may be broadcast or groupcast to one or more UEs via a common or shared radio network temporary identifier (RNTI), such as a paging RNTI (P-RNTI). For example, the second type of signaling 620 may be scrambled using the common or shared RNTI (e.g., a CRC scrambled by the common or shared RNTI).

In certain aspects, the second type of signaling 620 may include a paging DCI (e.g., a DCI scrambled using the P-RNTI), a paging early indicator (PEI), and/or a DCI designated or dedicated to indicating reconfiguration parameter(s) for random access communications (e.g., the second set of parameters). In certain aspects, the DCI designated for indicating reconfiguration parameter(s) for random access communications may be specific to a cell. For example, the DCI may be communicated using a cell specific RNTI. In certain aspects, the DCI designated for indicating reconfiguration parameter(s) for random access communications may be communicated in a PEI occasion or a paging occasion, for example, when PEI and/or paging is periodically scheduled for being communicated.

In certain aspects, the second type of signaling 620 may include one or more fields that indicate to switch from the first set of parameters 606 to the second set of parameters 608 (e.g., the first indication 632) and/or that indicate at least one parameter of the second set of parameters 608 (e.g., the second indication 634). For example, the second type of signaling 620 may include a short message indicator 622 that is set to a specific value (e.g., ‘00’ which may otherwise be a reserved value) that indicates to switch from the first set of parameters 606 to the second set of parameters 608 and/or indicates at least one parameter of the second set of parameters 608 (e.g., a parameter value and/or an index of a parameter value).

In some cases, the short message indicator 622 may indicate that a short message 624 is carried in the second type of signaling 620. The short message 624 may be or include a bitmap with one or more bits that indicate to switch from the first set of parameters 606 to the second set of parameters 608 and/or that indicate at least one parameter of the second set of parameters. For example, the short message 624 may have a size of eight bits, and any one or more of bits 5-8 in the short message 624 may be used to indicate to switch from the first set of parameters 606 to the second set of parameters 608 and/or indicate at least one parameter of the second set of parameters 608 (e.g., a parameter value and/or an index of a parameter value).

In certain aspects, the short message indicator 622 and one or more other fields 626 (hereinafter “the other field(s) 626”) may be used to indicate to switch from the first set of parameters 606 to the second set of parameters 608 and/or indicate at least one parameter of the second set of parameters 608. For example, the short message indicator 622 may be set to a specific value (e.g., ‘00’ which may otherwise be a reserved value) that indicates the other field(s) 626 carry information related to the second set of parameters 608, and the other field(s) 626 may indicate to switch from the first set of parameters 606 to the second set of parameters 608 and/or indicate at least one parameter of the second set of parameters 608. In certain aspects, the other field(s) 626 may include, for example, a frequency domain resource allocation field, a time domain resource allocation field, a modulation and coding scheme field, etc. As an example, the other field(s) 626 may be or include a resource allocation 628 and/or any other suitable field in the second type of signaling.

In certain aspects, the second type of signaling 620 may include scheduling for a payload 630, which may be communicated via a data channel, a control channel, and/or a shared data and control channel, for example, the PDSCH. As shown, the second type of signaling 620 may indicate or include a resource allocation 628 for communicating the payload 630, for example, in the PDSCH. The resource allocation 628 may include or indicate time-frequency resource(s) for communicating the payload 630. The payload 630 may indicate to switch from the first set of parameters 606 to the second set of parameters 608 and/or indicate or include at least one parameter of the second set of parameters 608.

Accordingly, the second type of signaling 620 and/or the payload 630 may indicate a modification to the configuration 604 based on the second set of parameters 608. The second type of signaling 620 and/or the payload 630 may carry a first indication 632 to switch to the second set of parameters 608 and/or a second indication 634 of at least one parameter of the second set of parameters 608. In some cases, the second type of signaling 620 and/or the payload 630 may indicate to switch from the first set of parameters 606 to the second set of parameters 608. In certain cases, the second type of signaling 620 and/or the payload 630 may indicate at least one parameter of the second set of parameters 608. Note that the second type of signaling 620 and/or the payload 630 may be used to trigger reconfiguration from the second set of parameters 608 to the first set of parameters 606, for example, using any of the techniques described herein.

The enhanced signaling described herein with respect to FIG. 6 may enable reduced latency in triggering reconfiguration of random access parameters. The enhanced signaling may also be communicated to multiple UEs via paging signaling (e.g., DCI scrambled with P-RNTI). Accordingly, the enhanced signaling may ensure that multiple UEs are quickly configured for random access parameters that enable energy savings, for example, through a longer periodicity for ROs, a shorter RAR window, and/or a reduced FDM number (among other settings), when traffic levels and/or network loads decrease. The enhanced signaling may enable switching to a configuration that increases random access communication activities, when traffic levels or network loads increase.

### Aspects Related to SSB to RO Mapping Random Access Configurations

In certain aspects, an RO (and/or a preamble) is associated with a specific SSB, for example, to help distribute random access communications across the ROs. As an example, a UE may measure the signal strength associated with multiple SSBs and select an SSB that has a signal strength above a certain threshold (e.g., a threshold reference signal received power (RSRP)). If none of the SSBs have a signal strength above the threshold, the UE may select any SSB among the candidate SSBs. Then, the UE may select a preamble belonging to (or associated with) the selected SSB. For example, a subset of preambles may be associated with a specific SSB. Thus, the preamble may indicate the SSB selected by the UE. Further, every SSB communicated by a network entity may be mapped to (or associated with) a specific RO. In some cases, multiples SSBs may be mapped to a single RO. The UE selects an RO associated with the selected SSB, and the UE may send the preamble in the selected RO as discussed herein with respect to FIGS. 5A and 5B. Accordingly, the SSB selection distributes preamble transmissions across the candidate ROs as the RO selection depends on the SSB selection. The association between an RO/preamble and an SSB allows a network entity to apply the same transmit beamforming as the SSB when sending the MSG2 transmission as discussed herein with respect to FIGS. 5A and 5B. Thus, the indication of the SSB selection with the preamble transmission conveys transmit beamforming information to the network entity.

In certain aspects, the first set of parameters and the second set of parameters may indicate an SSB to RO mapping. For example, each of the first set of parameters and the second set of parameters may include or indicate a random access configuration index (e.g., prach-ConfigurationIndex) that indicates a specific row of parameters in one or more look-up tables that define multiple SSB to RO mappings, where each row of parameters may indicate a different SSB to RO mapping.

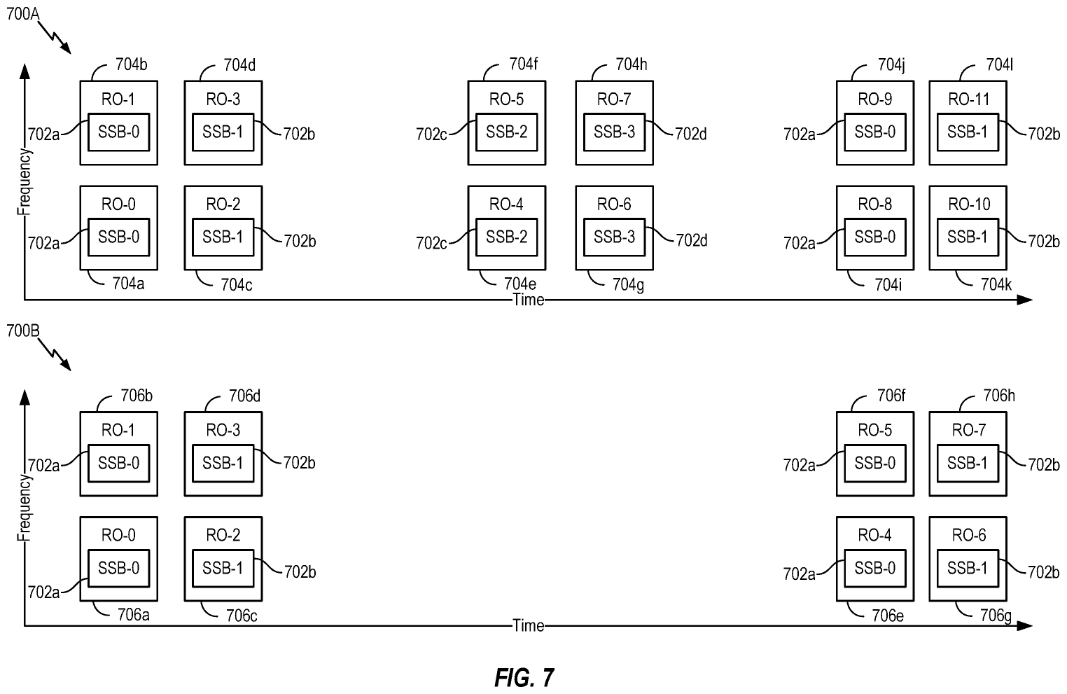

FIG. 7 illustrates example mappings 700A, 700B of SSBs to ROs for a first set of parameters (e.g., the first set of parameters 606) and a second set of parameters (e.g., the second set of parameters 608) in the time-frequency domains, respectively. In this example, there are a total of four SSBs 702a-d communicated by a network entity, and the FDM number is set to two, which allocates two FDM ROs in a time instance of a single RO. The second set of parameters are configured to allow certain ROs associated with the second set of parameters to overlap in time and frequency resources with a subset of the ROs associated with the first set of parameters.

The first mapping 700A has a total of twelve ROs 704a-1, and the second mapping 700B has a total of eight ROs 706a-h. The first mapping 700A maps the first SSB 702a to the first RO 704a and the second RO 704b. The second SSB 702b is mapped to the third RO 704c and the fourth RO 704d, and so on for the subsequent SSBs 702c, 702d and the ROs 704e-1.

The second mapping 700B may follow the first mapping 700A where the respective ROs overlap in time-frequency resources. For example, the first four ROs 706a-d of the second mapping 700B may have the same SSB to RO mapping as the first mapping 700A in the first four ROs 704a-d. The second mapping 700B lacks ROs that overlap with the fifth RO 704e through the eighth RO 704h of the first mapping 700A. The fifth RO 706e of the second mapping 700B may follow the SSB to RO mapping of the ninth RO 704i of the first mapping 700A, and so on for the sixth RO 706f through the eighth RO 706h of the second mapping 700B. For example, the sixth RO 706f through the eighth RO 706h of the second mapping 700B may apply the same SSB to RO mapping as the ninth RO 704i through the twelfth RO 7041 of the first mapping 700A, respectively. That is, the second mapping 700B may apply, for each of the ROs 706a-g, the same SSB to RO mapping as an RO of the first mapping 700A that overlaps in time and frequency with the respective RO 706a-g of the second mapping 700B. In other words, the second mapping 700B may be considered to apply the same SSB to RO mapping as the first mapping 700A. However, the second mapping 700B may effectively use virtual ROs that are not used for communications and fill in any missing ROs with respect to the first set of parameters for purposes of forming an SSB to RO mapping for the second set of parameters that follows the SSB to RO mapping for first set of parameters. Accordingly, the first set of parameters may effectively indicate the SSB to RO mapping (e.g., the second mapping 700B) for the second set of parameters. For example, the first set of parameters may indicate a mapping (e.g., the second mapping 700B) that indicates the first RO 706a is associated with the first SSB 702a, and so on for the other ROs 706b-h and SSBs 702a-d.

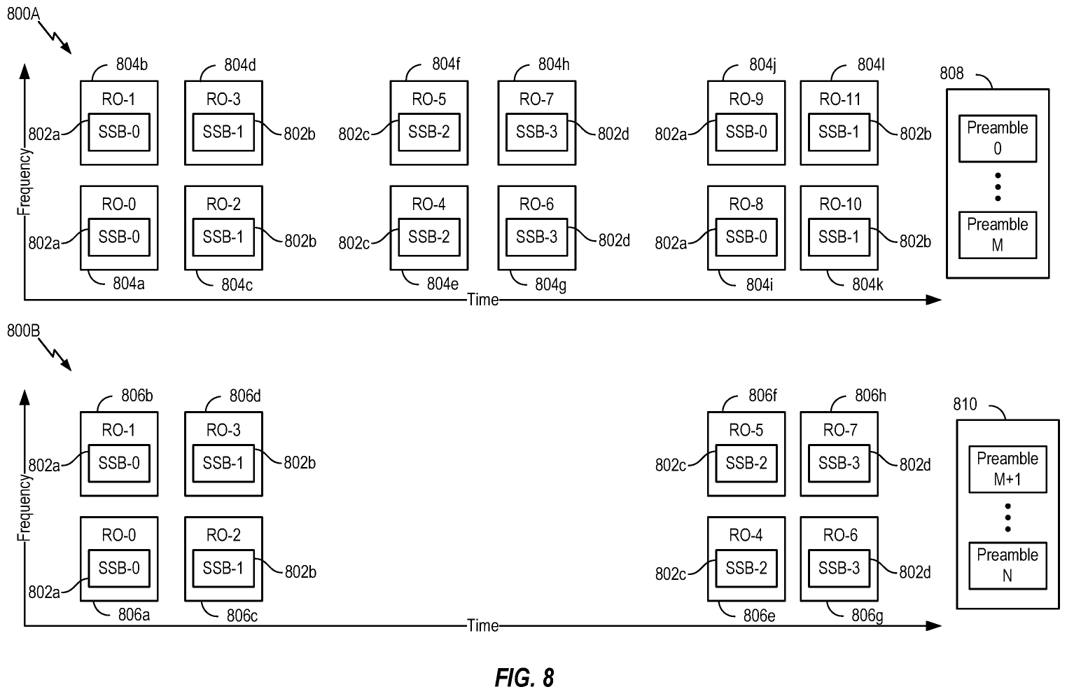

FIG. 8 illustrates other example mappings 800A, 800B of SSBs to ROs for a first set of parameters (e.g., the first set of parameters 606) and a second set of parameters (e.g., the second set of parameters 608) in the time-frequency domains, respectively. In this example, there are a total of four SSBs 802a-d communicated by a network entity, and the FDM number is set to two, which allocates two FDM ROs in a time instance of a single RO. The second set of parameters are configured to allow certain ROs associated with the second set of parameters to overlap in time and frequency with a subset of the ROs associated with the first set of parameters.

As shown, the first mapping 800A may apply the same mapping as described herein with respect to the first mapping 700A of FIG. 7. The second mapping 800B may apply a separate SSB to RO mapping from the first mapping 800A. The second mapping 800B may map the SSBs 802a-d to the ROs 806a-h without taking into account any of the missing ROs with respect to the first mapping 800A. For example, the first SSB 802a is mapped to the first RO 806a and the second RO 806b; the second SSB 802b is mapped to the third RO 806c and the fourth RO 806d; the third SSB 802c is mapped to the fifth RO 806e and the sixth RO 806f; and so on for the subsequent ROs associated with the second set of parameters. Accordingly, the second set of parameters may indicate the SSB to RO mapping (e.g., the second mapping 800B) for the second set of parameters. For example, the second set of parameters may indicate a mapping (e.g., the second mapping 800B) that indicates the first RO 806a is associated with the first SSB 802a, and so on for the other ROs 806b-h and SSBs 802a-d.

In order to distinguish the ROs 804a-1 of the first mapping 800A from the ROs 806a-h of the second mapping 800B, a first set of preambles 808 may be assigned to (or reserved for) random access communications based on the first set of parameters, and a second set of preambles 810 may be assigned to (or reserved for) random access communications based on the second set of parameters. The second set of preambles 810 may include one or more preambles that are different from the first set of preambles 808. In certain aspects, each of the first set of preambles 808 and the second set of preambles 810 may be a different subset of preambles from a common pool of preambles. For example, the first set of preambles 808 may include a preamble index of 0 through preamble index of M, and the second set of preambles 810 may include a preamble index of M+1 through a preamble index of N.

As an example, suppose a UE is configured to communicate random access communications based on the first set of parameters. If the UE selects the first SSB 802a in a random access procedure (for example, as discussed above, based on the RSRP), the UE may send a preamble from the first set of preambles 808 in the first RO 804a or the second RO 804b associated with the first set of parameters. Thus, the preamble from the first set of preambles 808 may indicate to a network entity that the UE is applying the first mapping 800A.

As another example, suppose a UE is configured to communicate random access communications based on the second set of parameters. If the UE selects the first SSB 802a in a random access procedure, the UE may send a preamble from the second set of preambles 810 in the first RO 806a or the second RO 806b associated with the second set of parameters. Thus, the preamble from the first second of preambles 810 may indicate to a network entity that the UE is applying the second mapping 800B.

Note that the mappings depicted in FIGS. 7 and 8 are examples. Other suitable SSB to RO mappings may be applied to the first set of parameters and/or the second set of parameters to enable dynamic configuration of random access communications.

In certain aspects, certain UEs may be unaware of the reconfiguration associated with the second set of parameters for random access communications, for example, due to the UEs not supporting the enhanced signaling described herein with respect to FIG. 6. In order to enable efficient channel usage for random access communications among a first set of UEs that support the enhanced signaling and a second set of UEs that do not support the enhanced signaling, the network entity may configure the second set of parameters such that the ROs associated with the second set of parameters overlap in time-frequency resources with a subset of ROs associated with the first set of parameters. As an example, the second set of parameters may increase the periodicity of the ROs such that the ROs associated with the second set of parameter coincide with a subset of ROs associated with the first set of parameters, for example, as depicted in FIGS. 7 and 8.

### Example Operations of Dynamic Configuration of Random Access Communications

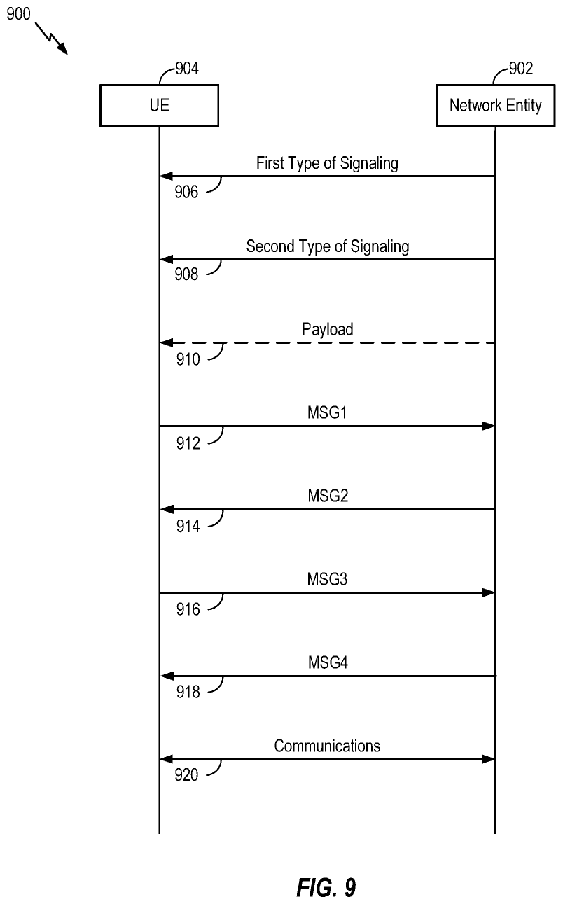

FIG. 9 depicts a process flow 900 for dynamic configuration of random access communications in a system between a network entity 902 and a user equipment (UE) 904. In some aspects, the network entity 902 may be an example of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 904 may be another type of wireless communications device and network entity 902 may be another type of network entity or network node, such as those described herein. Note that any operations or signaling illustrated with dashed lines indicates that that operation or signaling may be an optional or alternative example.

At 906, the UE 904 obtains, from the network entity 902 via a first type of signaling, a configuration that indicates at least a first set of parameters for random access communications, for example, as described herein with respect to FIG. 6. In certain aspects, the configuration may also indicate a second set of parameters for random access communications. The first set of parameters may be used during normal traffic levels and/or network loads, whereas the second set of parameters may be used during reduced traffic levels and/or network loads, for example, to enable energy savings at the network entity 902 and/or UE 904. The first type of signaling may be or include system information (e.g., SIB1).

At 908, the UE 904 obtains, from the network entity 902 via a second type of signaling, an indication of a modification to the configuration obtained at 906. As an example, the network entity 902 may determine that a traffic level is below a threshold, for example, the UE 904 may be in an idle state. The network entity 902 may decide to switch to the second set of parameters for random access communications to enable reduced power consumption associated with monitoring ROs, decoding or attempting to decode random access preambles in the ROs, and/or sending RARs. The modification to the configuration may be based on the second set of parameters. At least one parameter of the second set of parameters may be different than a corresponding parameter of the first set of parameters. For example, the periodicity of a set of ROs associated with the second set of parameters may have a longer duration than a corresponding periodicity associated with the first set of parameters. In certain aspects, the second type of signaling may indicate to switch from the first set of parameters to the second set of parameters. In certain aspects, the second type of signaling may indicate at least one parameter of the second set of parameters. In certain aspects, the second type of signaling may schedule a payload for transmission. In certain aspects, the second type of signaling may be or include control signaling, such as DCI, which may include a paging DCI and/or PEI.

At 910, the UE 904 obtains, from the network entity 902, the payload scheduled by the second type of signaling. The payload may be communicated via a PDSCH. The payload may indicate to switch from the first set of parameters to the second set of parameters. The payload may indicate at least one parameter of the second set of parameters.

At 912, the UE 904 sends, to the network entity 902, a random access preamble (MSG1) in a RACH based at least in part on the modification to the configuration. For example, the periodicity of the ROs and/or the FDM number may be modified by the second set of parameters, and thus, the second set of parameters may configure different locations for the ROs over time and/or frequency resources. The UE 904 may send the random access preamble in an RO that is allocated based on the modification to the configuration. In certain aspects, the UE may communicate the preamble using the SSB to RO mapping associated with the second set of parameters. As an example, the SSB to RO mapping associated with the second set of parameters may apply any of the second mappings described herein with respect to FIGS. 7 and 8.

At 914, the UE 904 obtains, from the network entity 902, a random access response (RAR) associated with the preamble transmission. In certain aspects, the UE 904 may obtain the RAR based at least in part on the modification to the configuration. For example, the duration of the RAR window in which the RAR is communicated may be modified by the second set of parameters. In some cases, the duration of the RAR window may be reduced by the second set of parameters. The RAR may also be referred to as MSG2. In certain aspects, the RAR may be communicated via a PDCCH and PDSCH transmission. For example, the UE 904 may obtain, from the network entity 902, a PDCCH transmission (e.g., DCI) scheduling the RAR on a PDSCH, and then the UE 904 may obtain, from the network entity 902, a PDSCH transmission carrying the RAR (e.g., a medium access control (MAC) protocol data unit (PDU) with a RAR payload associated with the preamble) in accordance with the scheduling indicated in the DCI. The RAR payload may indicate or include an UL grant for MSG3.

At 916, the UE 904 sends, from the network entity 902, MSG3 via a PUSCH in accordance with the UL grant indicated in the RAR. As an example, MSG3 may indicate or include an RRC connection request, a tracking area update, and/or a scheduling request (for an UL transmission).

At 918, the UE 904 obtains, from the network entity 902, a contention resolution message (MSG4) in response to MSG3. In some cases, the MSG4 may include an RRC connection setup message in response to the RRC connection request and/or an UL grant in response to the scheduling request, for example.

At 920, the UE 904 communicates with the network entity 902 based on the RACH communications. As an example, the UE 904 may apply any configuration for the communication link between the UE 904 and the network entity 902 as indicated or included in the RRC connection setup message. The RRC connection setup message may indicate or include various configurations, such as configuration(s) for control signaling (e.g., a PDCCH or a control resource set), PUSCH, PUCCH, PDSCH, transmit power control(s), channel state feedback reporting (e.g., CSI reporting), SRS, antenna configuration, and/or scheduling requests. In certain aspects, the configuration provided in the RRC connection setup message may facilitate the reception of subsequent configurations. In some cases, the UE 904 may transmit an UL signal in accordance with the UL grant provided in MSG4.

Note that the process flow 900 is an example of a contention based random access (CBRA) procedure. Other signaling may be used in addition to or instead of those illustrated in the process flow 900, such as signaling associated with a contention-free random access (CFRA) procedure and/or a two-step RACH procedure, for example, as described herein with respect to FIG. 5B. As an example, for CFRA, the UE 904 may obtain DCI that schedules the preamble transmission at 912, as described herein.

### Example Operations

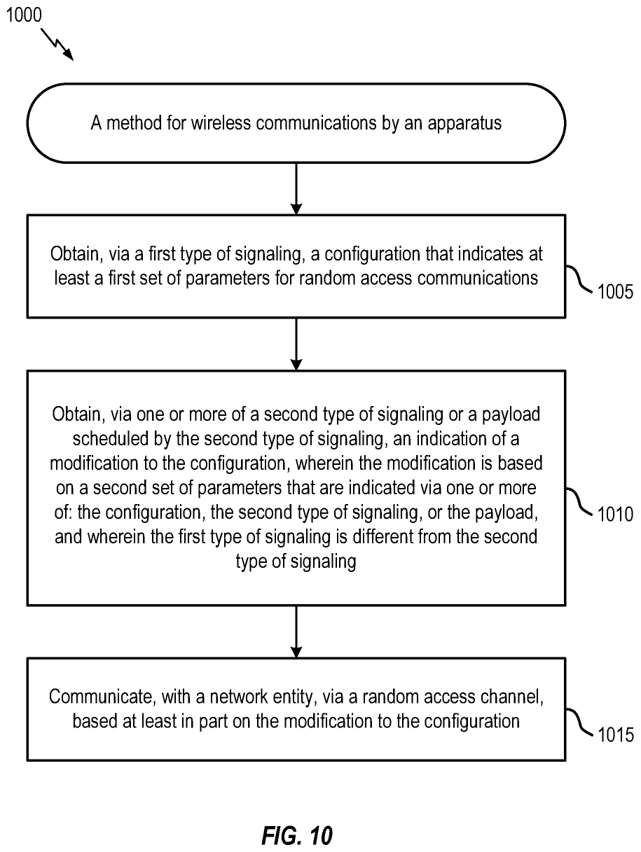

FIG. 10 shows a method 1000 for wireless communications by an apparatus, such as UE 104 of FIGS. 1 and 3.

Method 1000 begins at block 1005 with obtaining, via a first type of signaling, a configuration that indicates at least a first set of parameters for random access communications. In certain aspects, the first type of signaling comprises system information.

Method 1000 then proceeds to block 1010 with obtaining, via one or more of a second type of signaling or a payload scheduled by the second type of signaling, an indication of a modification to the configuration, wherein the modification is based on a second set of parameters that are indicated via one or more of: the configuration, the second type of signaling, or the payload, and wherein the first type of signaling is different from the second type of signaling. In certain aspects, the second type of signaling comprises DCI; and the payload is communicated via a PDSCH.

In certain aspects, the second set of parameters comprise one or more of: a total number of random access preambles; an indication of a mapping of a set of ROs to one or more SSBs; a periodicity for the set of ROs; a total number of one or more ROs that are frequency division multiplexed in a time instance associated with a single RO; or a duration of a random access response window. In certain aspects, the first set of parameters indicates a first periodicity for a set of ROs; the second set of parameters indicates a second periodicity for the set of ROs; and the second periodicity is different (e.g., longer or shorter) in duration than the first periodicity.

Method 1000 then proceeds to block 1015 with communicating, with a network entity, via a random access channel, based at least in part on the modification to the configuration, for example, as described herein with respect to FIG. 9. As an example, the apparatus may send a preamble in an RO allocated in time-frequency resource(s) indicated by the second set of parameters. As another example, the apparatus may monitor for a RAR in a RAR window having a duration indicated by the second set of parameters.

In certain aspects, the DCI includes a short message field having a specific value that indicates one or more of (i) at least one parameter of the second set of parameters or (ii) to switch from the first set of parameters to the second set of parameters.

In certain aspects, the DCI includes a short message indicator field that indicates one or more of (i) at least one parameter of the second set of parameters or (ii) to switch from the first set of parameters to the second set of parameters.

In certain aspects, the DCI includes: a short message indicator field having a specific value that indicates to switch from the first set of parameters to the second set of parameters; and one or more fields that indicate at least one parameter of the second set of parameters.

In certain aspects, the DCI includes scheduling that indicates the payload is communicated via the PDSCH; and the PDSCH includes an indication of at least one parameter of the second set of parameters.

In certain aspects, the DCI includes a PEI that indicates one or more of (i) at least one parameter of the second set of parameters or (ii) to switch from the first set of parameters to the second set of parameters.

In certain aspects, the DCI is designated for indicating one or more of (i) at least one parameter of the second set of parameters or (ii) to switch from the first set of parameters to the second set of parameters. In certain aspects, the second type of signaling is specific to a cell. In certain aspects, block 1010 includes obtaining the second type of signaling in one or more of: a PEI occasion or a paging occasion.

In certain aspects, block 1015 includes sending a message in a RO associated with a SSB, wherein the first set of parameters indicate a mapping that indicates the RO is associated with the SSB, for example, as described herein with respect to FIG. 7.

In certain aspects, block 1015 includes sending a message in a RO associated with a SSB, the message comprising a first preamble of a first set of preambles reserved for random access communications based on the second set of parameters. In certain aspects, the second set of parameters indicates a mapping that indicates the RO is associated with the SSB, for example, as described herein with respect to FIG. 8. In certain aspects, the first set of parameters indicate a second set of preambles reserved for random access communications based on the first set of parameters.

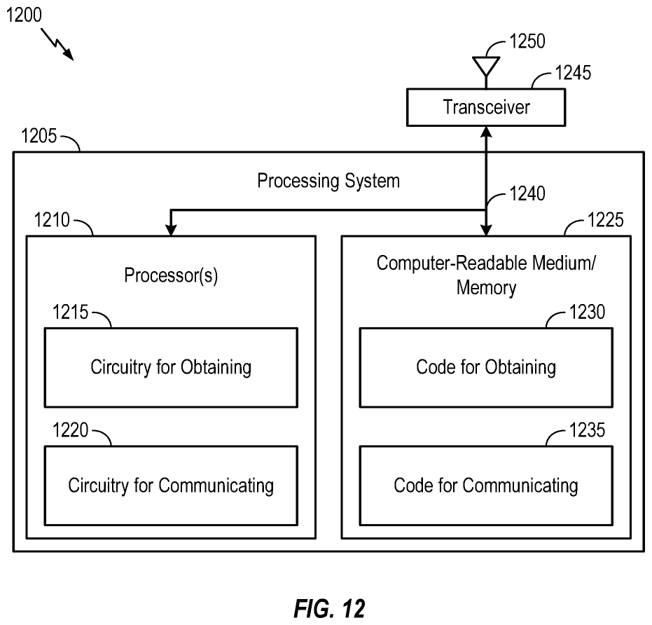

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

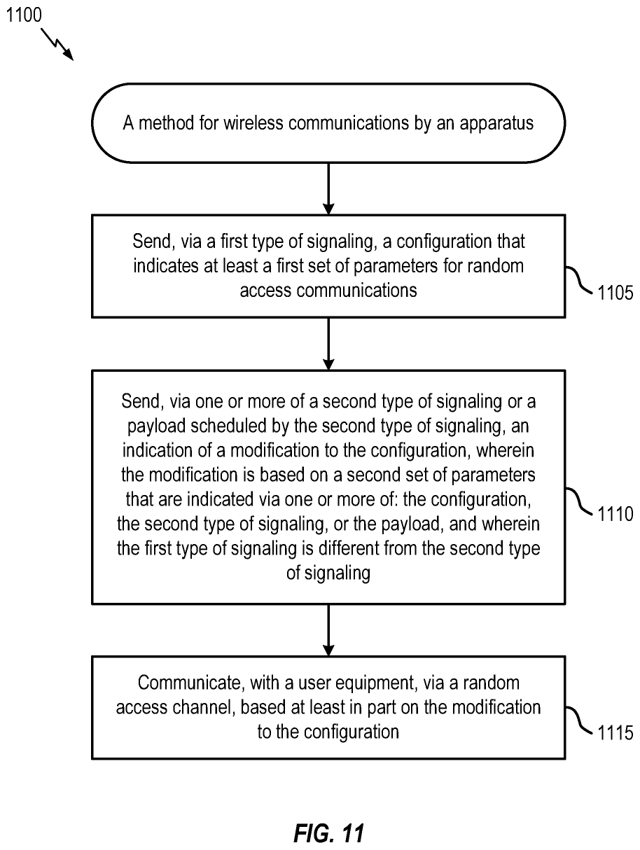

FIG. 11 shows a method 1100 for wireless communications by an apparatus, such as BS 102 of FIGS. 1 and 3, or a disaggregated base station as discussed with respect to FIG. 2.

Method 1100 begins at block 1105 with sending, via a first type of signaling, a configuration that indicates at least a first set of parameters for random access communications. In certain aspects, the first type of signaling comprises system information.

Method 1100 then proceeds to block 1110 with sending, via one or more of a second type of signaling or a payload scheduled by the second type of signaling, an indication of a modification to the configuration, wherein the modification is based on a second set of parameters that are indicated via one or more of: the configuration, the second type of signaling, or the payload, and wherein the first type of signaling is different from the second type of signaling. In certain aspects, the second type of signaling comprises DCI; and the payload is communicated via a PDSCH. In certain aspects, the second set of parameters comprise one or more of: a total number of random access preambles; an indication of a mapping of a set of ROs to one or more SSBs; a periodicity for the set of Ros; a total number of one or more ROs that are frequency division multiplexed in a time instance associated with a single RO; or a duration of a random access response window. In certain aspects, the first set of parameters indicates a first periodicity for a set of ROs the second set of parameters indicates a second periodicity for the set of ROs; and the second periodicity is different (e.g., longer or shorter) in duration than the first periodicity.

Method 1100 then proceeds to block 1115 with communicating, with a user equipment, via a random access channel, based at least in part on the modification to the configuration, for example, as described herein with respect to FIG. 9. As an example, the apparatus may obtain a preamble in an RO allocated in time-frequency resource(s) as indicated by the second set of parameters. As another example, the apparatus may send a RAR in a RAR window having a duration indicated by the second set of parameters.

In certain aspects, the DCI includes a short message field having a specific value that indicates one or more of (i) at least one parameter of the second set of parameters or (ii) to switch from the first set of parameters to the second set of parameters.

In certain aspects, the DCI includes a short message indicator field that indicates one or more of (i) at least one parameter of the second set of parameters or (ii) to switch from the first set of parameters to the second set of parameters.

In certain aspects, the DCI includes: a short message indicator field having a specific value that indicates to switch from the first set of parameters to the second set of parameters; and one or more fields that indicate at least one parameter of the second set of parameters.

In certain aspects, the DCI includes scheduling that indicates the payload is communicated via the PDSCH; and the PDSCH includes an indication of at least one parameter of the second set of parameters.

In certain aspects, the DCI includes a PEI that indicates one or more of (i) at least one parameter of the second set of parameters or (ii) to switch from the first set of parameters to the second set of parameters.

In certain aspects, the DCI is designated for indicating one or more of (i) at least one parameter of the second set of parameters or (ii) to switch from the first set of parameters to the second set of parameters. In certain aspects, the second type of signaling is specific to a cell. In certain aspects, block 1110 includes sending the second type of signaling in one or more of: a PEI occasion or a paging occasion.

In certain aspects, block 1115 includes obtaining a message in a RO associated with a SSB, wherein the first set of parameters indicate a mapping that indicates the RO is associated with the SSB, for example, as described herein with respect to FIG. 7.

In certain aspects, block 1115 includes obtaining a message in a RO associated with a SSB, the message comprising a first preamble of a first set of preambles reserved for random access communications based on the second set of parameters. In certain aspects, the second set of parameters indicates a mapping that indicates the RO is associated with the SSB, for example, as described herein with respect to FIG. 8. In certain aspects, the first set of parameters indicate a second set of preambles reserved for random access communications based on the first set of parameters.

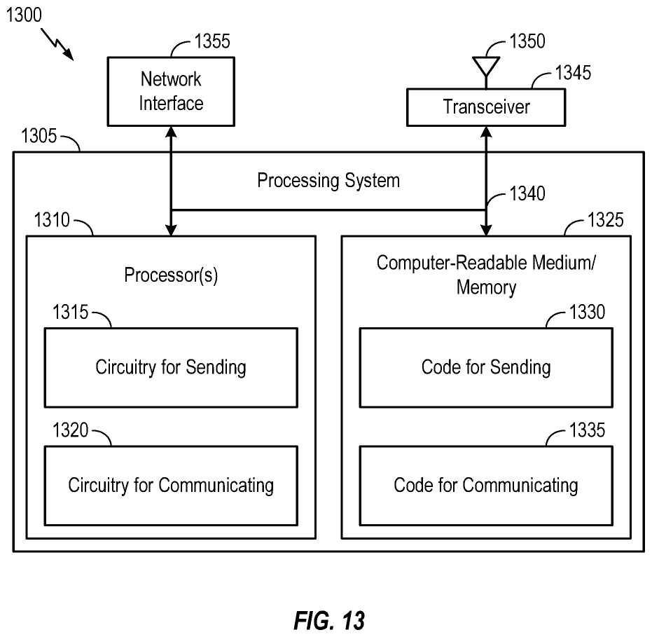

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to a transceiver 1245 (e.g., a transmitter and/or a receiver). The transceiver 1245 is configured to transmit and receive signals for the communications device 1200 via an antenna 1250, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1225 via a bus 1240. In certain aspects, the computer-readable medium/memory 1225 is configured to store instructions (e.g., computer-executable code) that when executed by the one or more processors 1210, enable and cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1225 stores code for obtaining 1230 and code for communicating 1235. Processing of the code 1230 and 1235 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1225, including circuitry for obtaining 1215 and circuitry for communicating 1220. Processing with circuitry 1215 and 1220 may enable and cause the communications device 1200 to perform the method 1000 described with respect to FIG. 10, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1245 and/or antenna 1250 of the communications device 1200 in FIG. 12, and/or one or more processors 1210 of the communications device 1200 in FIG. 12. Means for communicating, receiving or obtaining may include the transceivers 354, antenna(s) 352, receive processor 358, AI processor 370, and/or controller/processor 380 of the UE 104 illustrated in FIG. 3, transceiver 1245 and/or antenna 1250 of the communications device 1200 in FIG. 12, and/or one or more processors 1210 of the communications device 1200 in FIG. 12.

FIG. 13 depicts aspects of an example communications device 1300. In some aspects, communications device 1300 is a network entity, such as BS 102 of FIGS. 1 and 3, or a disaggregated base station as discussed with respect to FIG. 2.

The communications device 1300 includes a processing system 1305 coupled to a transceiver 1345 (e.g., a transmitter and/or a receiver) and/or a network interface 1355. The transceiver 1345 is configured to transmit and receive signals for the communications device 1300 via an antenna 1350, such as the various signals as described herein. The network interface 1355 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1325 via a bus 1340. In certain aspects, the computer-readable medium/memory 1325 is configured to store instructions (e.g., computer-executable code) that when executed by the one or more processors 1310, enable and cause the one or more processors 1310 to perform the method 1100 described with respect to FIG. 11, or any aspect related to it, including any operations described in relation to FIG. 11. Note that reference to a processor of communications device 1300 performing a function may include one or more processors of communications device 1300 performing that function, such as in a distributed fashion.

In the depicted example, the computer-readable medium/memory 1325 stores code for sending 1330 and code for communicating 1335. Processing of the code 1330 and 1335 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1325, including circuitry for sending 1315 and circuitry for communicating 1320. Processing with circuitry 1315 and 1320 may enable and cause the communications device 1300 to perform the method 1100 described with respect to FIG. 11, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1345, antenna 1350, and/or network interface 1355 of the communications device 1300 in FIG. 13, and/or one or more processors 1310 of the communications device 1300 in FIG. 13. Means for communicating, receiving or obtaining may include the transceivers 332, antenna(s) 334, receive processor 338, AI processor 318, and/or controller/processor 340 of the BS 102 illustrated in FIG. 3, transceiver 1345, antenna 1350, and/or network interface 1355 of the communications device 1300 in FIG. 13, and/or one or more processors 1310 of the communications device 1300 in FIG. 13.

### Example Clauses

Implementation examples are described in the following numbered clauses:

Clause 1: A method for wireless communications by an apparatus comprising: obtaining, via a first type of signaling, a configuration that indicates at least a first set of parameters for random access communications; obtaining, via one or more of a second type of signaling or a payload scheduled by the second type of signaling, an indication of a modification to the configuration, wherein the modification is based on a second set of parameters that are indicated via one or more of: the configuration, the second type of signaling, or the payload, and wherein the first type of signaling is different from the second type of signaling; and communicating, with a network entity, via a random access channel, based at least in part on the modification to the configuration.

Clause 2: The method of Clause 1, wherein the second set of parameters comprise one or more of: a total number of random access preambles; an indication of a mapping of a set of ROs to one or more SSBs; a periodicity for the set of ROs; a total number of one or more ROs that are frequency division multiplexed in a time instance associated with a single RO; or a duration of a random access response window.

Clause 3: The method of any one of Clauses 1-2, wherein: the first set of parameters indicates a first periodicity for a set of ROs; the second set of parameters indicates a second periodicity for the set of ROs; and the second periodicity is different (e.g., longer or shorter) in duration than the first periodicity.

Clause 4: The method of any one of Clauses 1-3, wherein: the second type of signaling comprises DCI; and the payload is communicated via a PDSCH.

Clause 5: The method of Clause 4, wherein the DCI includes a short message field having a specific value that indicates one or more of (i) at least one parameter of the second set of parameters or (ii) to switch from the first set of parameters to the second set of parameters.

Clause 6: The method of Clause 4 or 5, wherein the DCI includes a short message indicator field that indicates one or more of (i) at least one parameter of the second set of parameters or (ii) to switch from the first set of parameters to the second set of parameters.

Clause 7: The method of any one of Clauses 4-6, wherein the DCI includes: a short message indicator field having a specific value that indicates to switch from the first set of parameters to the second set of parameters; and one or more fields that indicate at least one parameter of the second set of parameters.

Clause 8: The method of any one of Clauses 4-7, wherein: the DCI includes scheduling that indicates the payload is communicated via the PDSCH; and the PDSCH includes an indication of at least one parameter of the second set of parameters.

Clause 9: The method of any one of Clauses 4-8, wherein the DCI includes a PEI that indicates one or more of (i) at least one parameter of the second set of parameters or (ii) to switch from the first set of parameters to the second set of parameters.

Clause 10: The method of any one of Clauses 4-9, wherein the DCI is designated for indicating one or more of (i) at least one parameter of the second set of parameters or (ii) to switch from the first set of parameters to the second set of parameters.

Clause 11: The method of any one of Clauses 1-10, wherein the second type of signaling is specific to a cell.

Clause 12: The method of any one of Clauses 1-11, wherein obtaining the indication comprises obtaining the second type of signaling in one or more of: a PEI occasion or a paging occasion.

Clause 13: The method of any one of Clauses 1-12, wherein communicating via the random access channel comprises sending a message in a RO associated with a SSB, wherein the first set of parameters indicate a mapping that indicates the RO is associated with the SSB.

Clause 14: The method of any one of Clauses 1-13, wherein communicating via the random access channel comprises sending a message in a RO associated with a SSB, the message comprising a first preamble of a first set of preambles reserved for random access communications based on the second set of parameters.

Clause 15: The method of Clause 14, wherein the second set of parameters indicates a mapping that indicates the RO is associated with the SSB.

Clause 16: The method of Clause 15, wherein the first set of parameters indicate a second set of preambles reserved for random access communications based on the first set of parameters.

Clause 17: The method of any one of Clauses 1-16, wherein the first type of signaling comprises system information.

Clause 18: A method for wireless communications by an apparatus comprising: sending, via a first type of signaling, a configuration that indicates at least a first set of parameters for random access communications; sending, via one or more of a second type of signaling or a payload scheduled by the second type of signaling, an indication of a modification to the configuration, wherein the modification is based on a second set of parameters that are indicated via one or more of: the configuration, the second type of signaling, or the payload, and wherein the first type of signaling is different from the second type of signaling; and communicating, with a user equipment, via a random access channel, based at least in part on the modification to the configuration.

Clause 19: The method of Clause 18, wherein the second set of parameters comprise one or more of: a total number of random access preambles; an indication of a mapping of a set of ROs to one or more SSBs; a periodicity for the set of ROs; a total number of one or more ROs that are frequency division multiplexed in a time instance associated with a single RO; or a duration of a random access response window.

Clause 20: The method of any one of Clauses 18-19, wherein: the first set of parameters indicates a first periodicity for a set of ROs; the second set of parameters indicates a second periodicity for the set of ROs; and the second periodicity is different (e.g., longer or shorter) in duration than the first periodicity.

Clause 21: The method of any one of Clauses 18-20, wherein: the second type of signaling comprises DCI; and the payload is communicated via a PDSCH.

Clause 22: The method of Clause 21, wherein the DCI includes a short message field having a specific value that indicates one or more of (i) at least one parameter of the second set of parameters or (ii) to switch from the first set of parameters to the second set of parameters.

Clause 23: The method of Clause 21 or 22, wherein the DCI includes a short message indicator field that indicates one or more of (i) at least one parameter of the second set of parameters or (ii) to switch from the first set of parameters to the second set of parameters.

Clause 24: The method of any one of Clauses 21-23, wherein the DCI includes: a short message indicator field having a specific value that indicates to switch from the first set of parameters to the second set of parameters; and one or more fields that indicate at least one parameter of the second set of parameters.

Clause 25: The method of any one of Clauses 21-24, wherein: the DCI includes scheduling that indicates the payload is communicated via the PDSCH; and the PDSCH includes an indication of at least one parameter of the second set of parameters.

Clause 26: The method of any one of Clauses 21-25, wherein the DCI includes a PEI that indicates one or more of (i) at least one parameter of the second set of parameters or (ii) to switch from the first set of parameters to the second set of parameters.

Clause 27: The method of any one of Clauses 21-26, wherein the DCI is designated for indicating one or more of (i) at least one parameter of the second set of parameters or (ii) to switch from the first set of parameters to the second set of parameters.

Clause 28: The method of any one of Clauses 18-27, wherein the second type of signaling is specific to a cell.

Clause 29: The method of any one of Clauses 18-28, wherein sending the indication comprises sending the second type of signaling in one or more of: a PEI occasion or a paging occasion.

Clause 30: The method of any one of Clauses 18-29, wherein communicating via the random access channel comprises obtaining a message in a RO associated with a SSB, wherein the first set of parameters indicate a mapping that indicates the RO is associated with the SSB.

Clause 31: The method of any one of Clauses 18-30, wherein communicating via the random access channel comprises obtaining a message in a RO associated with a SSB, the message comprising a first preamble of a first set of preambles reserved for random access communications based on the second set of parameters.

Clause 32: The method of Clause 31, wherein the second set of parameters indicates a mapping that indicates the RO is associated with the SSB.

Clause 33: The method of Clause 32, wherein the first set of parameters indicate a second set of preambles reserved for random access communications based on the first set of parameters.

Clause 34: The method of any one of Clauses 18-33, wherein the first type of signaling comprises system information.

Clause 35: One or more apparatuses, comprising: one or more memories comprising executable instructions; and one or more processors configured to execute the executable instructions and cause the one or more apparatuses to perform a method in accordance with any one of Clauses 1-34.

Clause 36: One or more apparatuses, comprising: one or more memories; and one or more processors, coupled to the one or more memories, configured to cause the one or more apparatuses to perform a method in accordance with any one of Clauses 1-34.

Clause 37: One or more apparatuses, comprising: one or more memories; and one or more processors, coupled to the one or more memories, configured to perform a method in accordance with any one of Clauses 1-34.

Clause 38: One or more apparatuses, comprising means for performing a method in accordance with any one of Clauses 1-34.

Clause 39: One or more non-transitory computer-readable media comprising executable instructions that, when executed by one or more processors of one or more apparatuses, cause the one or more apparatuses to perform a method in accordance with any one of Clauses 1-34.

Clause 40: One or more computer program products embodied on one or more computer-readable storage media comprising code for performing a method in accordance with any one of Clauses 1-34.

Clause 41: A user equipment (UE), comprising: a processing system that includes processor circuitry and memory circuitry that stores code and is coupled with the processor circuitry, the processing system configured to cause the UE to perform a method in accordance with any one of Clauses 1-17.

Clause 42: A network entity, comprising: a processing system that includes processor circuitry and memory circuitry that stores code and is coupled with the processor circuitry, the processing system configured to cause the network entity to perform a method in accordance with any one of Clauses 18-34.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain, via a first type of signaling, a configuration that indicates at least a first set of parameters for random access communications;
obtain, via one or more of a second type of signaling or a payload scheduled by the second type of signaling, an indication of a modification to the configuration, wherein the modification is based on a second set of parameters that are indicated via one or more of: the configuration, the second type of signaling, or the payload, and wherein the first type of signaling is different from the second type of signaling; and
communicate, with a network entity, via a random access channel, based at least in part on the modification to the configuration.

2. The apparatus of claim 1, wherein:
the first set of parameters indicates a first periodicity for a set of random access occasions (ROs);
the second set of parameters indicates a second periodicity for the set of ROs; and
the second periodicity is different in duration than the first periodicity.

3. The apparatus of claim 1, wherein:
the second type of signaling comprises downlink control information (DCI); and
the payload is communicated via a physical downlink control channel (PDSCH).

4. The apparatus of claim 3, wherein the DCI includes a short message field having a specific value that indicates one or more of (i) at least one parameter of the second set of parameters or (ii) to switch from the first set of parameters to the second set of parameters.

5. The apparatus of claim 3, wherein the DCI includes a short message indicator field that indicates one or more of (i) at least one parameter of the second set of parameters or (ii) to switch from the first set of parameters to the second set of parameters.

6. The apparatus of claim 3, wherein the DCI includes a paging early indicator (PEI) that indicates one or more of (i) at least one parameter of the second set of parameters or (ii) to switch from the first set of parameters to the second set of parameters.

7. The apparatus of claim 3, wherein the DCI is designated for indicating one or more of (i) at least one parameter of the second set of parameters or (ii) to switch from the first set of parameters to the second set of parameters.

8. The apparatus of claim 1, wherein to communicate via the random access channel, the one or more processors are configured to cause the apparatus to send a message in a random access occasion (RO) associated with a synchronization signal block (SSB), wherein the first set of parameters indicate a mapping that indicates the RO is associated with the SSB.

9. The apparatus of claim 1, wherein to communicate via the random access channel, the one or more processors are configured to cause the apparatus to send a message in a random access occasion (RO) associated with a synchronization signal block (SSB), the message comprising a first preamble of a first set of preambles reserved for random access communications based on the second set of parameters.

10. The apparatus of claim 9, wherein the second set of parameters indicates a mapping that indicates the RO is associated with the SSB.

11. The apparatus of claim 10, wherein the first set of parameters indicate a second set of preambles reserved for random access communications based on the first set of parameters.

12. The apparatus of claim 1, wherein the first type of signaling comprises system information.

13. An apparatus configured for wireless communications, comprising:
one or more memories; and
one or more processors coupled to the one or more memories, the one or more processors being configured to cause the apparatus to:
send, via a first type of signaling, a configuration that indicates at least a first set of parameters for random access communications;
send, via one or more of a second type of signaling or a payload scheduled by the second type of signaling, an indication of a modification to the configuration, wherein the modification is based on a second set of parameters that are indicated via one or more of: the configuration, the second type of signaling, or the payload, and wherein the first type of signaling is different from the second type of signaling; and
communicate, with a user equipment, via a random access channel, based at least in part on the modification to the configuration.

14. The apparatus of claim 13, wherein:
the first set of parameters indicates a first periodicity for a set of random access occasions (ROs);
the second set of parameters indicates a second periodicity for the set of ROs; and
the second periodicity is different in duration than the first periodicity.

15. The apparatus of claim 13, wherein:
the second type of signaling comprises downlink control information (DCI); and
the payload is communicated via a physical downlink control channel (PDSCH).

16. The apparatus of claim 15, wherein the DCI includes a short message field having a specific value that indicates one or more of (i) at least one parameter of the second set of parameters or (ii) to switch from the first set of parameters to the second set of parameters.

17. The apparatus of claim 15, wherein the DCI includes a short message indicator field that indicates one or more of (i) at least one parameter of the second set of parameters or (ii) to switch from the first set of parameters to the second set of parameters.

18. The apparatus of claim 15, wherein the DCI includes a paging early indicator (PEI) that indicates one or more of (i) at least one parameter of the second set of parameters or (ii) to switch from the first set of parameters to the second set of parameters.

19. The apparatus of claim 15, wherein the DCI is designated for indicating one or more of (i) at least one parameter of the second set of parameters or (ii) to switch from the first set of parameters to the second set of parameters.

20. A method for wireless communications by an apparatus, comprising:
obtaining, via a first type of signaling, a configuration that indicates at least a first set of parameters for random access communications;
obtaining, via one or more of a second type of signaling or a payload scheduled by the second type of signaling, an indication of a modification to the configuration, wherein the modification is based on a second set of parameters that are indicated via one or more of: the configuration, the second type of signaling, or the payload, and wherein the first type of signaling is different from the second type of signaling; and
communicating, with a network entity, via a random access channel, based at least in part on the modification to the configuration.
